(19) United States
(12) Patent Application Publication
(10) Pub. No.: US 2026/0030270 A1
(43) Pub. Date: Jan. 29, 2026

(54) ORCHESTRATING MACHINE LEARNING MODELS TO CREATE SAFE, ROBUST, PERSONALIZED, BRAND EXPERIENCES BETWEEN USERS AND AN ARTIFICIAL INTELLIGENCE AGENT

(71) Applicant: Qualtrics, LLC, Provo, UT (US)

(72) Inventors: Gurdeep Singh Pall, Seattle, WA (US); Kalyan Shankar Basu, Sammamish, WA (US)

(21) Appl. No.: 18/940,609

(22) Filed: Nov. 7, 2024

Related U.S. Application Data
(60) Provisional application No. 63/675,926, filed on Jul. 26, 2024.

(51) Int. Cl. G06F 16/332; G06F 21/60

(52) U.S. Cl. CPC G06F 16/3329; G06F 21/60

(57) ABSTRACT

One or more embodiments described herein include an experience management system that uses a centrally hosted agent architecture that leverages artificial intelligence models to accomplish inter-platform and cross-platform tasks to create personalized experiences throughout a user’s product or service journey. Indeed, the experience management system hosts and coordinates a multi-agent framework that receives user input or a user status, creates prompts from the user input or status to request other agents to perform tasks or subtasks related to providing a result and/or response to a user’s client device. In addition, the experience management system can access a knowledge graph containing user data to incorporate the user data during the coordination of responding to the user. Thus, when the knowledge graph is leveraged by the multi-agent framework, the experience management system can generate personalized and customized experiences for a user.

### CROSS-REFERENCE TO RELATED APPLICATIONS

This application claims the benefit of, and priority to, U.S. Provisional Application No. 63/675,926, entitled “ORCHESTRATING MACHINE LEARNING MODELS TO CREATE SAFE, ROBUST, PERSONALIZED, BRAND EXPERIENCES BETWEEN USERS AND AN ARTIFICIAL INTELLIGENCE AGENT,” filed July 26, 2024, the contents of which are incorporated by reference herein in their entirety.

### BACKGROUND

Recent years have seen significant advancement in hardware and software platforms that attempt to create personalized experiences for users. For instance, many traditional systems facilitate the acquisition of user data from various sources. Indeed, many conventional systems utilize the acquired user data to target products and/or advertisements at a user. In addition, some traditional systems can monitor user interactions with digital content to determine user preferences from the interactions. Despite these capabilities, traditional systems suffer from a variety of technical deficiencies that limit the ability of traditional systems to seamlessly provide a personalized user experience, especially relating to enabling artificially intelligent platforms to interface with third-party platforms in a secure and operationally flexible manner. Thus, there are several disadvantages regarding traditional customer experience systems.

Indeed, traditional systems often facilitate single-modal communication for artificially intelligent platforms. Single-modal communications are limited in both the quantity of actions that can be facilitated for a user account, as well as the quality of actions for the user-account. Indeed, modern customer journeys often can cross various systems owned and managed by different parties as well as multiple devices that are owned and controlled by different parties. Accordingly, the single-modal communication limitation of traditional systems creates a problem that is necessarily rooted in technology artificially intelligent platforms.

One reason traditional systems are often single-modal is because of the technical challenge to keeping traditional systems secure. Indeed, it is often difficult to secure a single-modal communication platform, and traditional systems have no way of securing larger systems with respect to malicious attacks (e.g., jail breaking, data poisoning, prompt injection, reverse prompt engineering, among others). Moreover, traditional systems fail to ensure that AI generated actions and content will provide an intended experience because traditional systems are unable to detect hallucination from models or detect malicious actions with respect to the system. Accordingly, these and other security risks inherently arise within the technical field of artificial intelligent platforms.

Additionally, traditional systems are operationally inflexible. For example, in addition to only facilitating single-modal communications, and despite the wealth of data collected for user accounts, traditional systems provide impersonalized, segregated user experiences for a user account because traditional systems lack the flexibility to be able to access, manage, connect, and utilize actions and data from various computing systems across a user journey. Indeed, traditional systems often require burdensome integration steps, data transformation steps, and other computationally onerous processes that are often not worth the effort because of the inflexibility of traditional systems.

These along with additional problems and issues exist with regard to traditional communicating systems.

### SUMMARY

Embodiments of the present disclosure provide benefits and/or solve one or more of the foregoing or other problems in the art with systems, non-transitory computer-readable media, and methods that facilitate cross-modal communication of artificially intelligent platforms to securely and flexibly provide seamless personalized, holistic experiences for a user account across multiple modalities. For example, the disclosed systems can leverage a monitoring agent layer to receive a user prompt. The disclosed systems can utilize the monitor agent layer to screen the user prompt for any malicious attacks (e.g., security threats to the disclosed systems). Indeed, the disclosed systems can serve as both an active firewall type function that uses an agent layer to monitor for security threats by detecting attack vectors hidden within AI prompts, and a passive firewall type function that uses the agent layer to safeguards private information to prevent unwarranted disclosures of personal information.

Moreover, the disclosed systems can utilize an orchestrator agent layer to process the prompt to generate one or more task prompts from the user prompts. Indeed, the disclosed systems can utilize the orchestrator layer to autonomously determine a workflow from the user prompt. Indeed, in some respects, the disclosed systems can utilize the orchestrator agent layer to augment the user prompt. Furthermore, the disclosed systems can provide the task prompts to a large language model (e.g., a pre-trained large language model and/or a fine-tuned large language model) to cause the pre-trained large language model to generate one or more task responses (e.g., updates for the user account). In addition, the disclosed systems can cause the orchestrator agent layer to receive the one or more task responses and utilize the one or more task responses to orchestrate task items by providing task item instructions corresponding to the task items to platform agents. Indeed, the disclosed systems can determine to provide task item instructions to internal platform agents and/or third-party platform agents. Moreover, the disclosed systems can generate a user response based on a task item status received from a platform agent.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an experience management system operates in accordance with one or more embodiments.

FIGS. 2A-J illustrate an overview of user interfaces the experience management system creates to provide assistance to a user account in accordance with one or more embodiments.

FIG. 3 illustrates an overview diagram of the experience management system generating task item responses and task item statuses in response to receiving a user prompt in accordance with one or more embodiments.

FIG. 4 illustrates a block diagram of an example architecture for the experience management system in accordance with one or more embodiments.

FIG. 5 illustrates a flowchart of a series of acts for generating task item responses and task item statuses in accordance with one or more embodiments.

FIG. 6 illustrates a block diagram of an exemplary computing device in accordance with one or more embodiments.

FIG. 7 illustrates a network environment of an experience management system in accordance with one or more embodiments.

### DETAILED DESCRIPTION

One or more embodiments described herein include an experience management system that uses a centrally hosted agent architecture that leverages artificial intelligence models to accomplish inter-platform and cross-platform tasks to create personalized experiences throughout a user’s product or service journey. Indeed, the experience management system hosts and coordinates a multi-agent framework that receives user input or a user status, creates prompts from the user input or status to request other agents to perform tasks or subtasks related to providing a result and/or response to a user’s client device. Indeed, the experience management system leverages the multi-agent framework to generate code, create instructions, send prompts to third-party agent systems, or to send and receive user data from third-party platforms. In addition, the experience management system can access a knowledge graph containing user data to incorporate the user data during the coordination of responding to the user. Thus, when the knowledge graph is leveraged by the multi-agent framework, the experience management system can generate very personalized and customized experiences for a user. Moreover, the experience management system provides a security layer that monitors user input as well as monitors responses to provide a layer of security to keep personal data safe, as well as to provide a quality control function to make sure that the response or result generated by the artificial intelligence models meet quality standards dictated by an experience provider.

As a general overview, the experience management system can receive a user prompt from a client device associated with a user. The experience management system can utilize a monitoring agent layer to monitor prompt characteristics associated with the user prompt, as will be explained in more detail below. The experience management system can cause the monitoring agent layer to provide the user prompt to an orchestrator agent layer. Moreover, the experience management system can cause the orchestrator agent layer to determine one or more task prompts from the user prompt. The experience management system can provide the one or more task prompts to a pre-trained large language model to generate one or more task responses based on the one or more task prompts. Moreover, the pre-trained large language model can include (e.g., can be enhanced by) one or more fine-tuned layers. Indeed, the experience management system can orchestrate one or more task items based on the orchestrator agent layer receiving the one or more task items by providing a first task item instruction to an internal platform agent or a second task item instruction to a third-party platform agent. The experience management system can generate a user response to the user prompt according to a task item status received from the internal platform agent or the third-party platform agent.

As just mentioned, the experience management system can receive a user prompt at a monitoring layer. Specifically, the experience management system can receive the user prompt from a client device associated with a user via a channel. In one example, the user prompt is input directly input by a user (e.g., via voice, text). In other examples, however, a user prompt can be system generated based on an update to a user status along a product or experience journey.

As previously mentioned, the experience management system can receive the user prompt at a monitoring agent layer and can monitor the user prompt prior to providing the user prompt to an orchestrator agent layer. For example, the experience management system can cause the monitoring agent layer to monitor the user prompt by analyzing the user prompt for security threats (e.g., jailbreaks in the user prompt). Moreover, the experience management system can cause the monitoring agent layer to monitor the user prompt by analyzing the user prompt for clarity, and edit, augment, or otherwise transform the user prompt according to the analysis.

In addition, the experience management system can provide the user prompt to the orchestrator agent layer and cause the orchestrator agent layer to process the user prompt. For example, the experience management system can cause the orchestrator agent layer to process the user prompt by analyzing the user prompt to determine task items from the user prompt. The experience management system can cause the orchestrator agent layer to generate one or more task items from the user prompt (e.g., from the task items determined from the user prompt). In addition, the orchestrator agent layer can orchestrate an order of requests or events with one or more agents within the experience management system or with third-party platform agents outside the experience management system. Indeed, the experience management system can provide the one or more task prompts, via one or more agents, to a pre-trained large language model (LLM) comprising one or more fine-tuned layers to generate one or more task responses based on the one or more task prompts.

As previously mentioned, the experience management system can cause the orchestrator agent layer to orchestrate one or more task items. Indeed, the experience management system can orchestrate the one or more task items by providing a first task item instruction to an internal platform agent or a second task item instruction to a third-party platform agent. Indeed, the experience management system can determine whether the internal platform agent or the third-party platform agent can execute a task item instruction (e.g., the first task item instruction or the second task item instruction) and provide the task item instruction to the corresponding platform agent (e.g., the internal platform agent or the third-party platform agent).

As previously mentioned, the experience management system can generate a user response to the user prompt according to a task item status received from a platform agent (e.g., an internal platform agent or a third-party platform agent). Indeed, the experience management system can provide the user response to the user via a user interface associated with a client device. The user response can include one or more task item statuses and one or more task items the experience management system completed.

The experience management system provides several advantages over traditional systems. For instance, the experience management system solves the technologically rooted problem of artificially intelligent platforms often being limited to single-modal communications by providing an advanced artificial intelligence architecture that includes an orchestrator agent layer to facilitate communication and interaction with third-party platforms. The orchestrator agent layer provides an advanced orchestration solution that facilitates communication between different third-party systems, different communication protocols, different data schemas, and different device requirements to achieve a multi-modal, multi-platform, and multi-system orchestration architecture facilitating deeply personalized and customized experiences that leverages capabilities, knowledge graphs, and data from different specialized platforms and systems.

Moreover, the experience management system increases the security of traditional systems by utilizing an advanced monitoring agent layer. Through the monitoring agent layer, the experience management system can actively and passively improve the security of traditional systems both by actively and passively monitoring user prompts. Indeed, through the monitoring agent layer, the experience management system can both actively prevent malicious attacks on traditional systems and passively monitor access of content items by internal and third-party platforms. In addition, the monitoring agent layer is designed to monitor AI generated content and actions to enforce quality control measures, ensure brand tone and messaging, and/or otherwise confirm that the experience management system generated an appropriate response or conducted appropriate actions in view of an original user prompt.

In addition, and as described further herein, the experience management system increases the operational flexibility of traditional systems by enabling user accounts to have seamless, tailored experiences across multiple modalities and platforms. Indeed, the experience management system provides an architecture that includes specialized adapters that provide data transformation, customized API calls, customized prompt generation, and other actions that facilitate communication between multiple different services, databases, and third-party systems and platforms. The specialized adaptors, in combination with an internal agent layer, results in increased flexibility for the experience management system compared to traditional systems.

As illustrated by the foregoing discussion, the present disclosure utilizes a variety of terms to describe features and advantages of the experience management system. Additional detail is now provided regarding the meaning of such terms. For example, as used herein, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the LLM recommendation system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content item summaries or other generated content items) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a large language model.

As used herein, the term “channel” can refer to a client device or one or more modalities associated with a client device. For example, a channel can be a smartphone, tablet, laptop, computer, or streaming system (e.g., seat-back screens or overhead screens), among others. Additionally or alternatively, a channel can be a mode of sending or receiving communication through a client device, such as a phone call, an instant message, or a voice command, among others. Accordingly, channels can be multi-modal. For example, the experience management system can receive a voice command (e.g., a user prompt) requesting information about flights to and from a destination location.

Moreover, as used herein, the term “monitoring agent layer” can be an artificial intelligence (AI) agent or autonomous software program that monitors prompt characteristics of prompts received via a plurality of connected channels. Along similar lines, the term “orchestrator agent layer” can be an AI agent or autonomous software program that interacts with the monitoring agent layer, as well as one or more large language models, internal platform agents, third-party platform agents, and/or third-party applications/application program interfaces.

As used herein, the term “prompt characteristics” refers to aspects of a user prompt. For example, prompt characteristics can be a type of the user prompt, one or more linguistic patterns of the user prompt, how the user prompt was received, or security aspects of the prompt.

Relatedly, the term “task prompts” refers to instructions relating to the user prompt that the experience management system creates and provides to the pre-trained large language model. For example, the experience management system can cause the orchestrator agent layer to determine one or more tasks from the user prompt, and provide a task prompt corresponding to each task to the pre-trained LLM. Moreover, as used herein, the phrase “task responses” refers to a description of a task corresponding to a task prompt. The experience management system can provide task responses to a user to inform a user of what progress is being made in relation to the user prompt.

In addition, as used herein, the phrase “task item” refers to an action that the experience management system causes the orchestrator agent layer to assign to an internal platform agent, a third-party platform agent, or a third-party application/application program interface. A subtask item is an intermediate task that is needed to complete a task item. Relatedly, as used herein, the term “internal platform agent” refers to an artificial intelligence agent of the experience management system that is trained to perform a task. Along the same lines, the term “third-party platform agent” refers to an artificial intelligence agent hosted on a third-party server or a third-party cloud environment.

Moreover, as used herein, the term “task item status” refers to a status of a task item associated with a task item instruction. For example, a task item status can indicate that the experience management system has successfully completed a task item instruction, that the experience management system has failed a task item instruction, or that the experience management system is still in the process of carrying out the task item instruction.

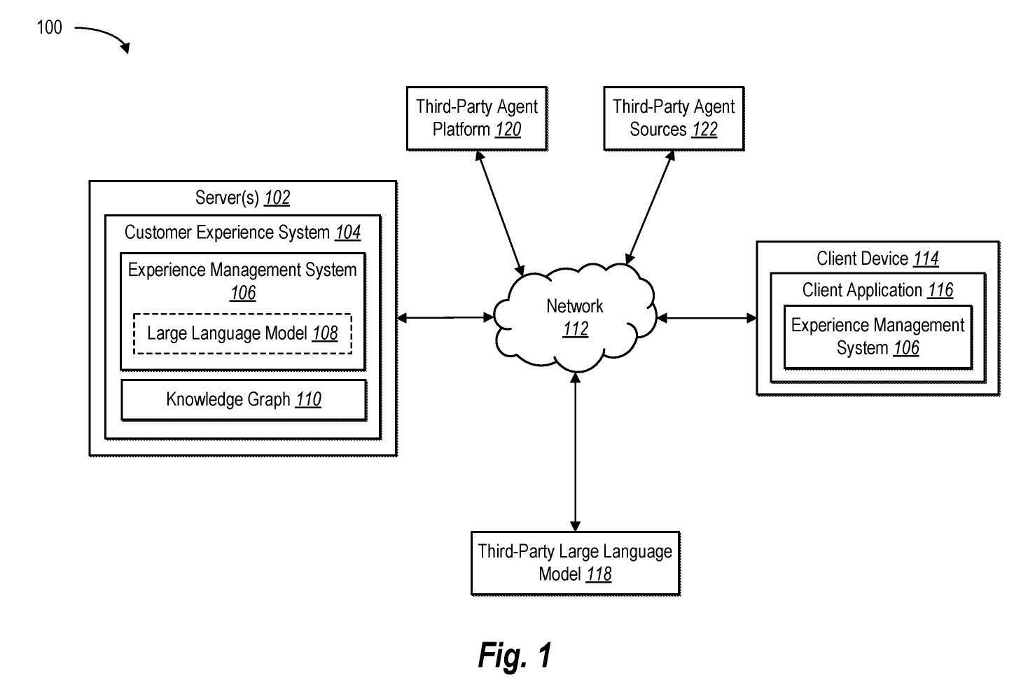

Additional details regarding the experience management system will now be provided with reference to the figures. For example, FIG. 1 illustrates a schematic diagram of an exemplary system environment (“environment”) 100 in which an experience management system 106 operates. As illustrated in FIG. 1, the environment 100 includes server(s) 102, a network 112, a client device 114, a third-party large language model 118, a third-party agent platform 120, and third-party services 122.

Although the environment 100 of FIG. 1 is depicted as having a particular number of components, the environment 100 is capable of having any number of additional or alternative components (e.g., any number of server devices, client devices, third-party servers, or other components in communication with the experience management system 106 via the network 112). Similarly, although FIG. 1 illustrates a particular arrangement of the server(s) 102, the network 112, the client device 114, the third-party large language model 118, the third-party agent platform 120 and the third-party services 122, various additional arrangements are possible.

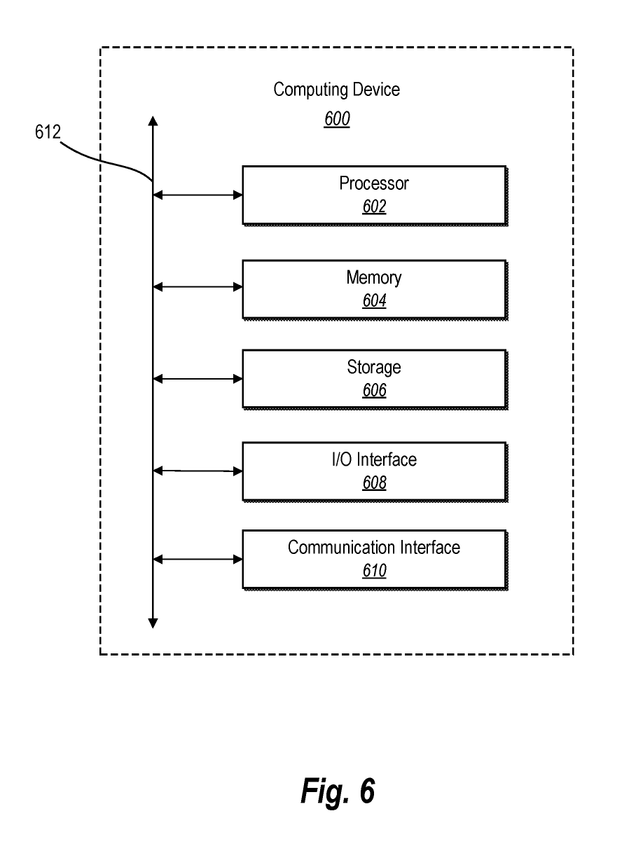

The server(s) 102, the network 112, the client device 114, the third-party large language model 118, the third-party agent platform 120 and the third-party services 122, are communicatively coupled with each other either directly or indirectly (e.g., through the network 112 discussed in greater detail below in relation to FIG. 6). Moreover, the server(s) 102, the client device 114, the third-party large language model 118, the third-party agent platform 120 and the third-party services 122, each include one of a variety of computing devices (including one or more computing devices as discussed in greater detail with relation to FIG. 6).

As mentioned above, the environment 100 includes the server(s) 102. In one or more embodiments, the server(s) 102 generates, stores, receives, and/or transmits data, including user prompts, task prompts, task responses, task item instructions, task statuses, and/or user responses. In one or more embodiments, the server(s) 102 comprises a data server. In some implementations, the server(s) 102 comprises a communication server or a web-hosting server.

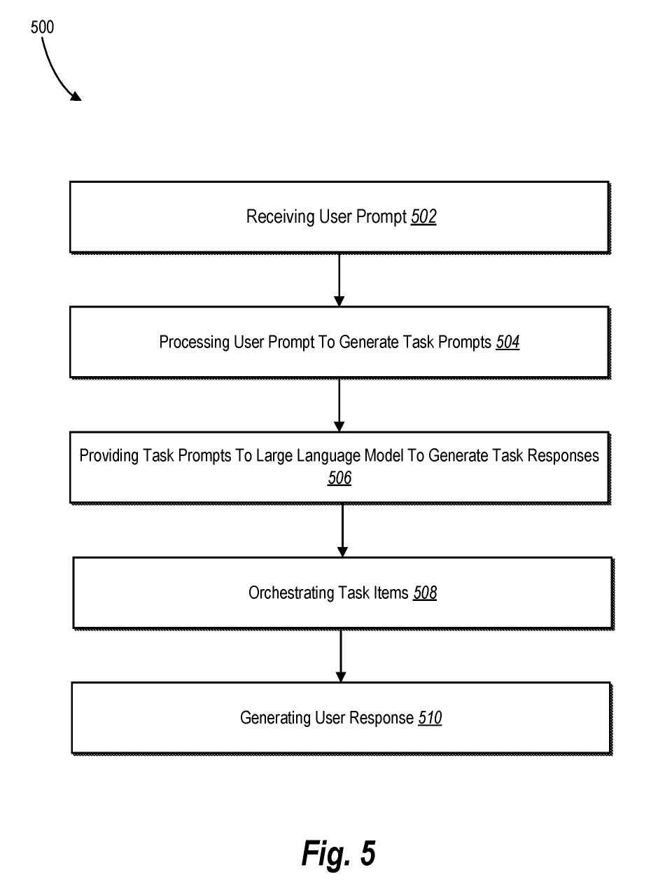

As mentioned above, the environment 100 includes a client device 114. The client device 114 can be one of a variety of computing devices, including a smartphone, a tablet, a smart television, a desktop computer, a laptop computer, a virtual reality device, an augmented reality device, or another computing device as described in relation to FIGS. 5-6. The client device 114 can communicate with the server(s) 102 via the network 112. For example, the client device 114 can receive user input from a user interacting with the client device 114 (e.g., via a client application 116) to, for instance, access, generate, modify, or share a content item, to collaborate with a co-user of a different client device, or to select a user interface element. In addition, the experience management system 106 on the server(s) 102 can receive information relating to various interactions with content items and/or user interface elements based on the input received by the client device 114.

As shown, the client device 114 can include a client application 116. In particular, the client application 116 may be a web application, a native application installed on the client device 114 (e.g., a mobile application, a desktop application, etc.), or a cloud-based application where all or part of the functionality performed by the server(s) 102. Based on instructions from the client application 116, the client device 114 can present or display information, including a user response the experience management system 106 generates according to a user prompt.

In one or more embodiments, the customer experience system 104 provides functionality that facilitates a communication between participants. For example, in some implementations, the customer experience system 104 provides functionality for transmitting and/or recording a communication between users. In some embodiments, the customer experience system 104 provides functionality that more specifically assists one user in communicating with another user. For instance, the customer experience system 104 can provide functionality that enables a device of one of the users (e.g., a device used to transmit the communication or a separate, supplementary device) to display information relevant to the communication (e.g., to display information for the other user(s) participating in the communication, such as identifying information or account information).

In some embodiments, the customer experience system 104 can include a knowledge graph 110 of the customer experience system 104. For example, the knowledge graph can include nodes representing users within the customer experience system 104 and edges connecting the nodes that represent relationships between the users of the customer experience system. The knowledge graph can include demographic data as well as other user data that can be used to generate customized responses and actions by the experience management system.

Additionally, the server(s) 102 include the experience management system 106. In one or more embodiments, the experience management system 106, via the server(s) 102, provides a personalized user experience for a third-party service. For instance, in some cases, the experience management system 106, via the server(s) 102, receives a user prompt. The experience management system 106 can determine tasks according to the user prompt, and utilize a knowledge graph to generate a user response customized to the user. The experience management system 106 can utilize the knowledge graph to complete the tasks from the user prompt in a way that is uniquely catered to the user. In some cases, via the server(s) 102, the experience management system 106 generates a user response to a user prompt according to a task item status received from an internal platform agent and/or a third-party agent platform 120. Additionally, in some embodiments, the experience management system 106 can include an internal large language model 108 that is native to, housed or hosted on, and/or otherwise maintained by the experience management system 106.

Moreover, the environment 100 can include a third-party large language model 118. A third-party server can host the third-party large language model 118 for access by the experience management system 106 (e.g., as an alternative to the server(s) 102 hosting or housing the internal large language model 108). For example, the third-party large language model 118 can be external to the experience management system 106, but the experience management system 106 can nevertheless access and utilize the third-party large language model 118 via one or more plugins, APIs, or other network-based protocols.

As illustrated, the environment 100 can include a third-party agent platform 120. A third-party server can host the third-party agent platform 120 for access by the experience management system 106. For example, the third-party agent platform 120 can be external to the experience management system 106, but the experience management system 106 can nevertheless access and utilize the third-party agent platform 120 via one or more plugins, APIs, or other network-based access protocols.

Additionally, the environment 100 can include third-party services 122. A third-party server can host the third-party services 122 for access by the experience management system 106. For example, the third-party services 122 can be external to the experience management system 106, but the experience management system 106 can nevertheless access and utilize the third-party services 122 via one or more plugins, APIs, or other network-based access protocols.

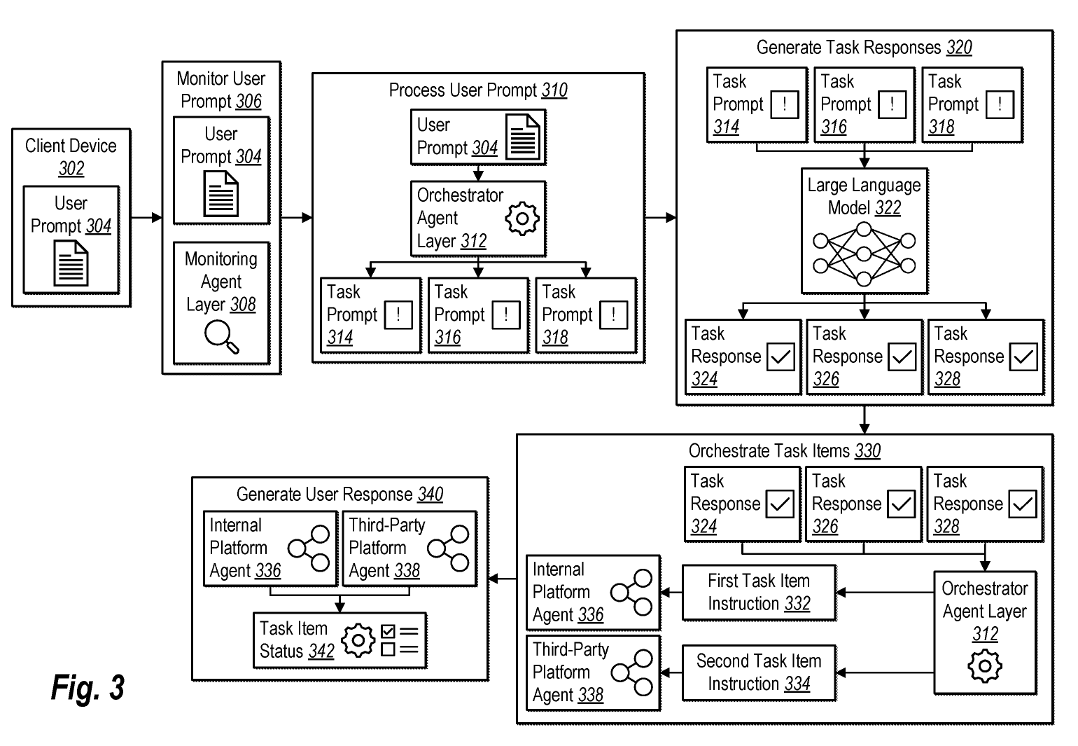

As previously mentioned, the experience management system 106 can generate task item responses based on receiving a user prompt. FIG. 3 illustrates the experience management system 106 receiving a user prompt, monitoring and processing the user prompt, generating task prompts from the user prompt, generating task responses according to the task prompts, orchestrating task items according to the task responses, and generating a user response including a task item status.

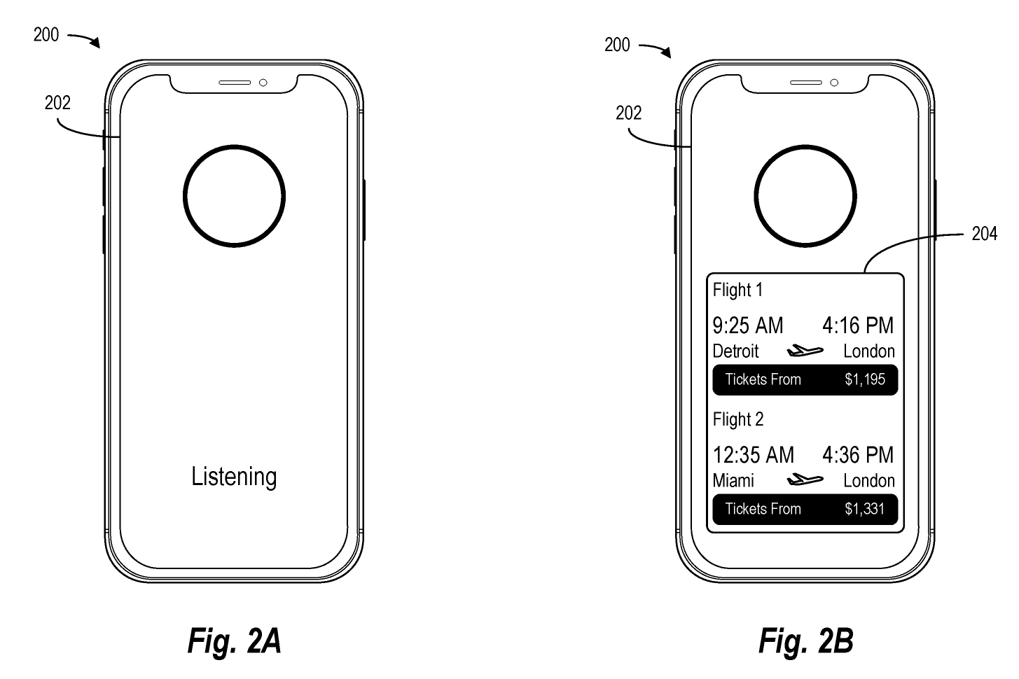

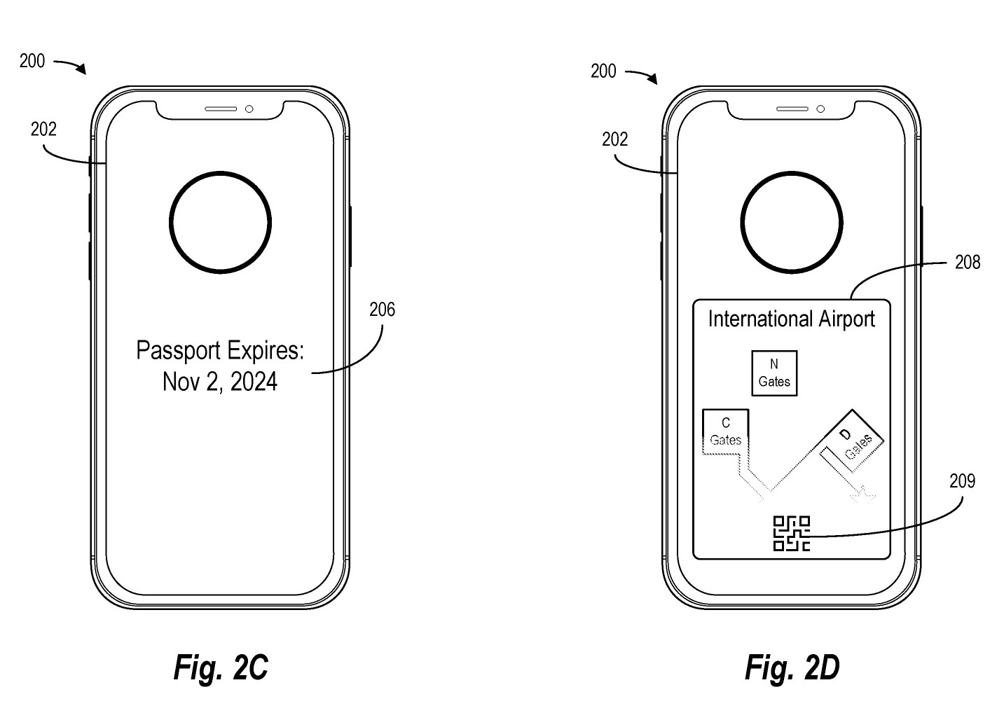

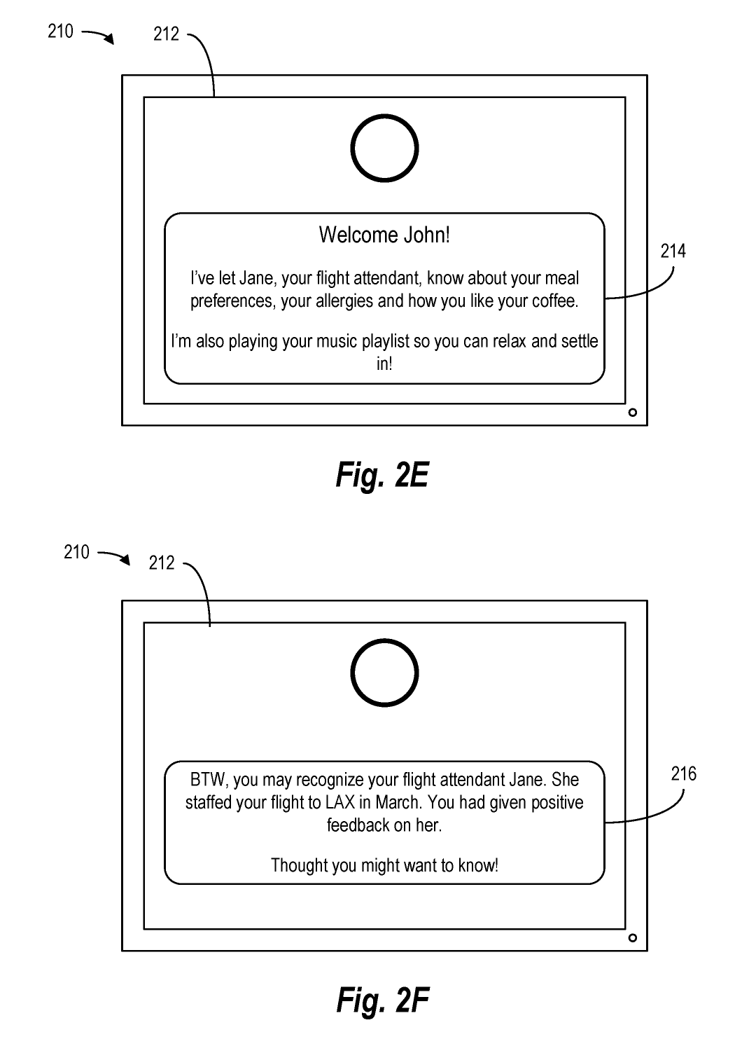

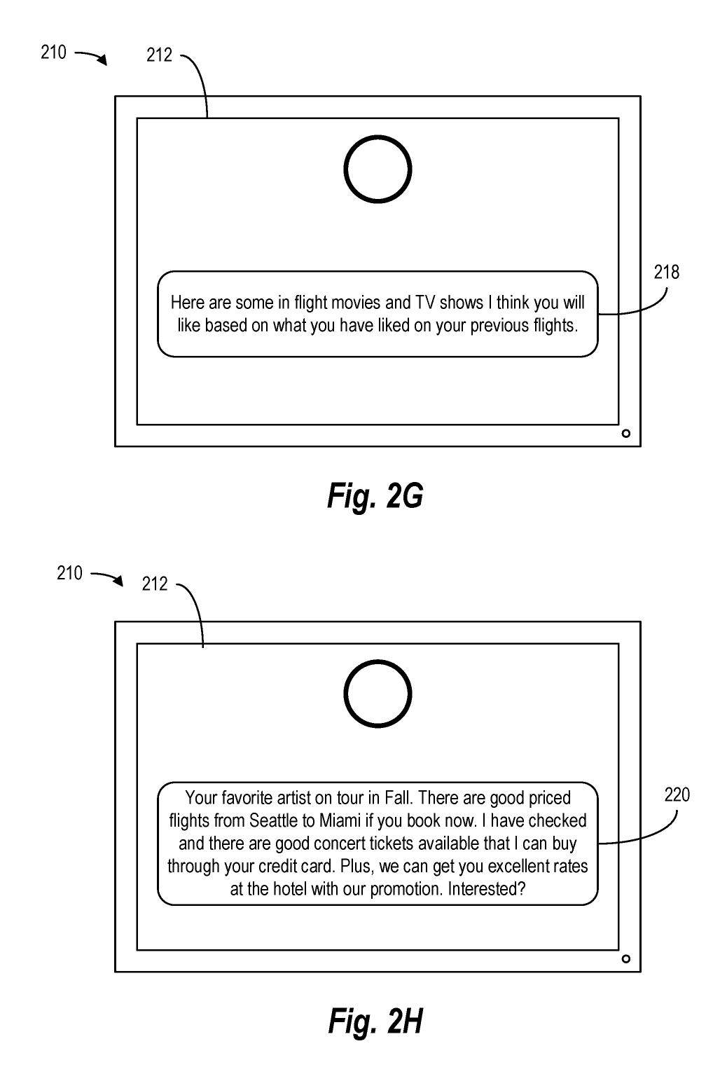

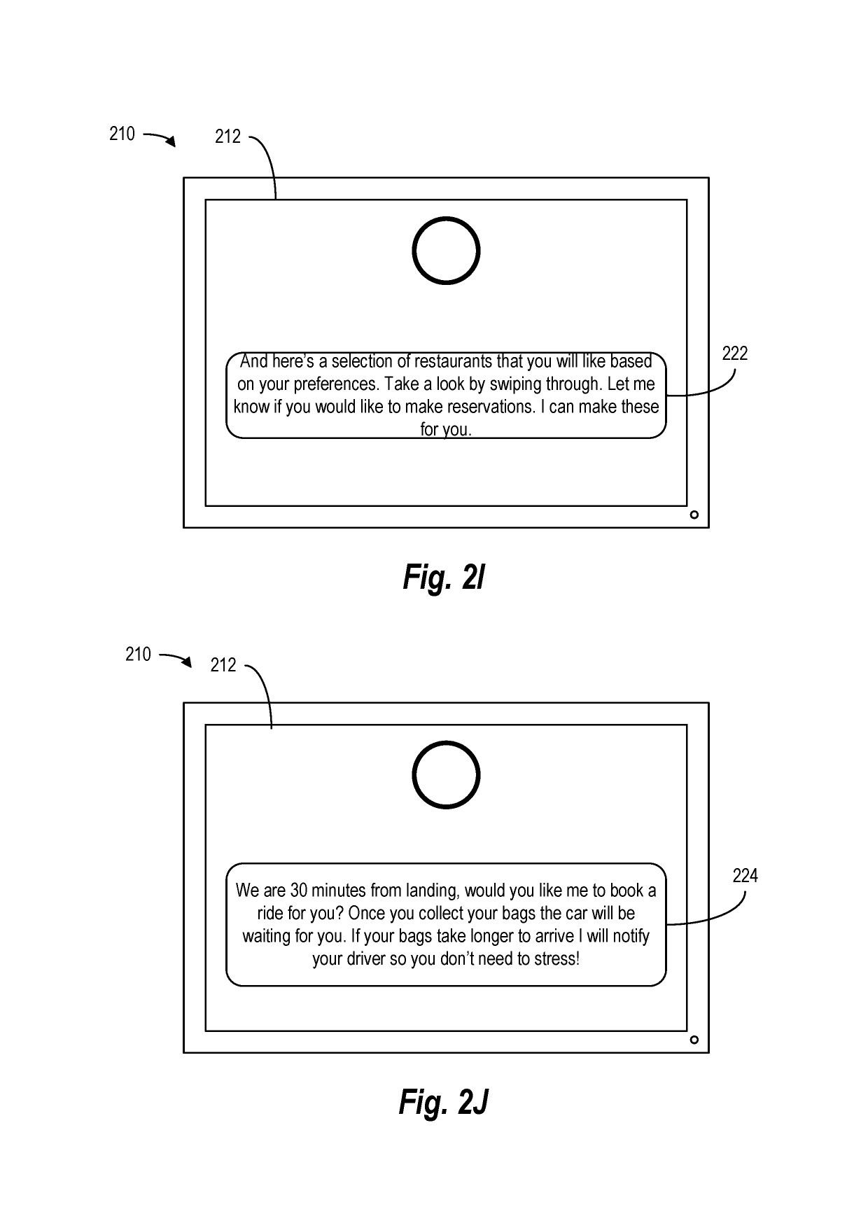

As previously mentioned, the experience management system 106 generates user interfaces to provide assistance to user accounts. FIGS. 2A-J illustrate example user interfaces and user responses the experience management system 106 generates for a user account in accordance with one. Specifically, FIGS. 2A-D illustrate interactions between the experience management system 106 and a user account before the user account travels, FIGS. 2E-J illustrate autonomous actions the experience management system 106 can perform for the user account while the user account travels. The user experience illustrated in FIGS. 2A-J is only one example and is given as an overview to the types and characteristics of user experiences the experience management system 106 can generate and execute. The experience management system can generate similar types of experiences with similar characteristics in other industries, as one skilled in the art will understand.

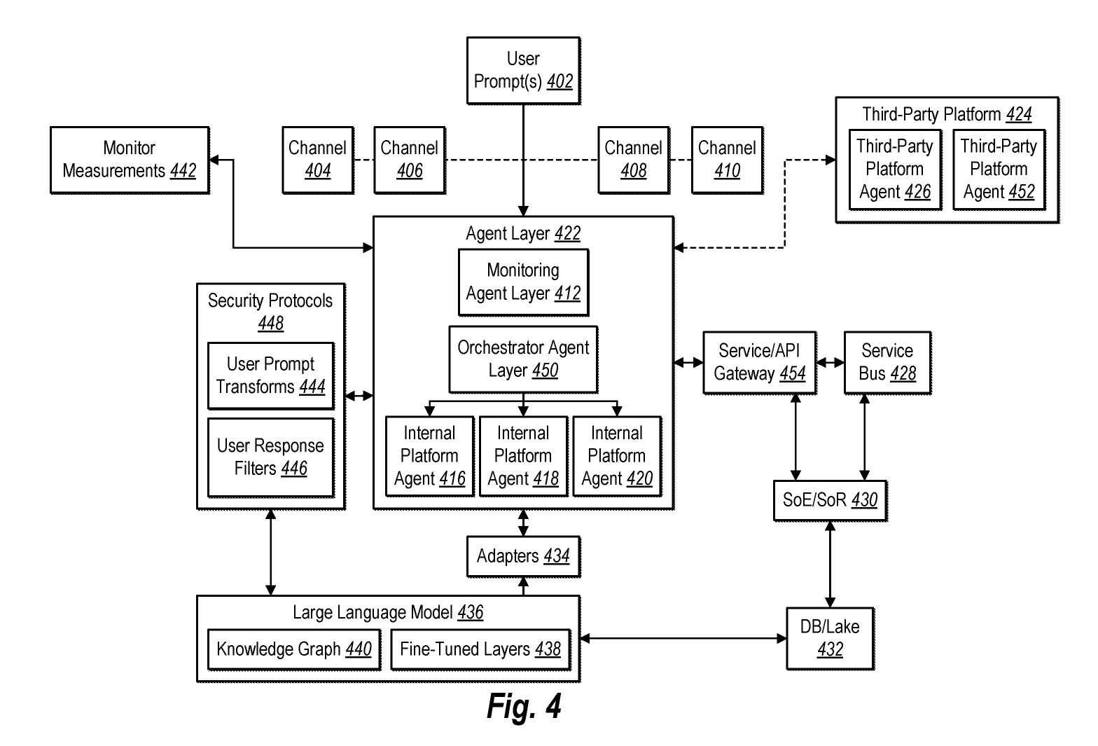

As shown in FIG. 2A, the experience management system 106 can generate a first user interface 202 in a first client device 200. The experience management system 106 can utilize the first user interface 202 to receive user prompts from the user account. For example, the experience management system 106 can receive user prompts of various forms and through various channels, such as audio inputs or text inputs. For example, the experience management system 106 can receive a user prompt requesting the experience management system 106 to schedule flights from two different origin cities to a destination city within a specific timeframe. The experience management system 106 can utilize an orchestrator agent layer to determine tasks from the user prompt and orchestrate completion of the tasks. More information regarding the orchestrator agent layer can be found below with regard to FIGS. 3 and 4.

Continuing with the same example, as shown in FIG. 2B, responsive to receiving the user prompt, the experience management system 106 can generate a first user response 204 to display in the first user interface 202 of the first client device 200. The experience management system 106 can generate the first user response 204 to include one or more selectable options for the user account. For example, the first user response can include information about a first flight from a first origin city to a destination city with a first time of arrival, and information about a second flight from a second origin city to the destination city with a second time of arrival. The experience management system 106 can determine, autonomously or from the user prompt, to constrain the first and second times of arrival to be within a certain amount of time of each other (e.g., within an hour).

Moreover, the experience management system 106 can utilize the orchestrator agent layer to perform an action regarding to the first user response. For example, the experience management system 106 can receive input from the user account to purchase the flight tickets and utilize the orchestrator agent layer to perform a first action to confirm the purchase. Alternatively, the experience management system 106 can determine an absence of a response from a user account and utilize the orchestrator agent layer to perform a second action, such as to reserve the tickets for a period of time (e.g., a day). Indeed, the experience management system 106 can receive additional input from the user account regarding the content of the first user response 204 and update the content of the first user response 204, such as by determining to replace the first flight and/or the second flight with a new flight.

Indeed, responsive to receiving the user prompt from the user account, the experience management system 106 can determine to perform an autonomous action (e.g., an action not indicated to the experience management system 106 by the user prompt) for the user account. As shown in FIG. 2C, the experience management system 106 can generate a third user response 206 in the first user interface 202 of the first client device 200. Responsive to receiving a user prompt to make travel plans (e.g., as discussed previously with regard to FIGS. 2A-B), the experience management system 106 can analyze the user prompt to determine tasks related to the user prompt to autonomously perform for the user account. For example, where the user prompt relates to travel plans, the experience management system 106 can determine other requirements related to traveling, such as the need for a passport. The experience management system 106 can determine whether the user account is associated with a passport and if so when the passport expires. The experience management system 106 can generate the third user response 206 to inform the user account of this expiration, and can receive input from the user account to perform an action accordingly.

Indeed, the experience management system 106 can continue to determine to perform autonomous tasks for the user account relating to the user prompt. As shown in FIG. 2D, the experience management system 106 can monitor a user account progression relating to the user prompt, such as traveling to a destination (e.g., as discussed above with regard to FIGS. 2A-B). For example, the experience management system 106 can generate a third user response 208 relating to a travel itinerary in the first user interface 202 of the first client device 200. Indeed, the experience management system 106 can monitor events relating to travel for the user account (e.g., by detecting information such as changes in location and/or travel speed). Specifically as shown in FIG. 2D, the experience management system 106 can determine that a user account arrived at a destination (e.g., an international airport) early, and generate the third user response 208 that includes a map of the international airport the user account is traveling out of, along with a QR code 209 to grant the user account access to a lounge.

As shown in FIG. 2E, the experience management system 106 can interface with one or more client devices associated with a user account. The experience management system 106 can interface with a second client device 210 (such as a client device on an airplane during a flight). Indeed, the experience management system 106 can generate a fourth user response 214 for display in a second user interface 212 of the second client device 210.

For example, after arriving at the airport for a planned trip as discussed previously with regard to FIGS. 2A-D and boarding the plane, the experience management system 106 can generate the fourth user response 214 to provide information about a flight associated with the user account. In this instance, the fourth user response 214 is an update for the user account informing the user account that the experience management system 106 has shared personal preferences of the user account, such as meal preferences, allergies, and coffee preferences, in addition to informing the user account that the experience management system 106 is playing their music playlist. Indeed, the experience management system 106 can utilize an orchestrator agent layer to interface with client devices of other systems and exchange information.

As shown in FIG. 2F, the experience management system 106 can generate a fifth user response 216 to display in the second user interface 212 of the second client device 210. Continuing on the example of a trip as discussed in FIGS. 2A-E, the experience management system 106 can autonomously include information about flight personnel on the flight. For example, the experience management system 106 can interface with third party systems and/or otherwise determine flight personnel, and compare the flight personnel with previous flight personnel associated with the user account to determine any recurring flight personnel. Moreover, the experience management system 106 can receive feedback on flight personnel and/or determine feedback of previous flight personnel.

Indeed, as shown in FIG. 2G, the experience management system 106 can further generate a sixth user response 218 in the second user interface 212 of the second client device 210. Continuing in example discussed above in FIGS. 2A-F, the experience management system 106 can autonomously generate recommendations for movies and TV shows for the user account in the sixth user response 218. Indeed, the experience management system 106 can determine the recommendations according to movies and TV shows the user account has previously provided feedback for, or based on previous feedback, among other mechanisms of determining the feedback.

As illustrated in FIG. 2H, the experience management system 106 can generate a seventh user response 220 to display in the second user interface 212 of the second client device 210. Continuing in the example discussed previously with regard to FIGS. 2A-G, the experience management system 106 can autonomously generate a recommendation for the user account to attend a concert in the seventh user response 220. Indeed, the experience management system 106 can include information about ticket pricing, travel and discounts in the seventh user response 220.

As illustrated in FIG. 2I, the experience management system 106 can generate an eighth user response 222 to display in the second user interface 212 of the second client device 210. Continuing in the example discussed previously with regard to FIGS. 2A-H, the experience management system 106 can autonomously generate restaurant recommendations for the user account and include the restaurant recommendation in the eighth user response 222. The experience management system 106 can determine the restaurant recommendations according to feedback from the user account or by interfacing with third party systems.

As illustrated in FIG. 2J, the experience management system 106 can generate a ninth user response 224 to display in the second user interface 212 of the second client device 210. Continuing in the example discussed previously with regard to FIGS. 2A-I, the experience management system 106 can offer to schedule transportation from the airport to a destination for the user account. Indeed, the experience management system 106 can schedule the transportation for the user account in a manner that streamlines the user account’s transition from the airport to the destination. Indeed, with regard to the autonomous actions performed by the user account with regard to FIGS. 2E-J, the experience management system 106 can receive user input in response to the autonomous action. The experience management system 106 an utilize the user input to determine what further actions to perform for the user account. As illustrated in FIG. 3, the experience management system 106 can receive a user prompt 304 via an application of a client device 302. For example, the experience management system 106 can receive a user prompt 304 requesting the experience management system 106 to book a first flight from Los Angeles to London within a specified timeframe, a second flight from Boston to London within the specified timeframe, and request that the first and second flights arrive at London within an hour of each other.

As shown in FIG. 3., the experience management system 106 can perform an act 306 to monitor the user prompt 304. Indeed, as a part of the act 306, the experience management system 106 can provide the user prompt 304 to a monitoring agent layer 308. The experience management system 106 can cause the monitoring agent layer 308 to monitor the user prompt 304 to determine characteristics of the user prompt 304. For example, the experience management system 106 can cause the monitoring agent layer 308 to determine security threats, such as jailbreaks. For example, the experience management system 106 can cause the monitoring agent layer 308 to monitor the user prompt 304 for types of jailbreaks such as prompt-injection attacks (e.g., direct or indirect), context manipulation (e.g., role-playing or chain of prompts), or model confusion (e.g., ambiguous prompts or prompt overloading), among others.

As illustrated, the experience management system 106 can perform an act 310 to process the user prompt. Indeed, as part of the act 310, the experience management system 106 can provide the user prompt 304 to an orchestrator agent layer 312. Moreover, the experience management system 106 can cause the orchestrator agent layer 312 to generate one or more task prompts (e.g., a task prompt 314, a task prompt 316, and a task prompt 318), from the user prompt 304. To continue from the above-mentioned example where the user prompt 304 included request to find flights from Los Angeles and Boston to London within the specified timeframe that arrive within an hour of each other, the experience management system 106 can generate the task prompt 314 to find flights from Los Angeles to London within the specified timeframe. Moreover, the experience management system 106 can generate the task prompt 316 to find flights from Boston to London within the specified timeframe. Additionally, the experience management system 106 can generate the task prompt 318 to determine that the flight from Los Angeles to London and the flight from Boston to London arrive within an hour of each other. Accordingly, when performing the act 310 to process the user prompt, the experience management system 106 can generate independent task prompts, such as a prompt to book a flight from a first city to a second city. Additionally, when performing the act 310 to process the user prompt, the experience management system 106 can generate dependent task prompts that depend on one or more task prompts to filter a criteria of an independent task prompt, such as, for example, to restrict an arrival time of a flight based on one or more parameters. In some embodiments, the experience management system 106 can determine the one or more parameters of a dependent task prompt autonomously, whereas in some embodiments, the experience management system 106 can determine the one or more parameters of the dependent task prompt according to input from a user.

Indeed, as illustrated, the experience management system 106 can perform an act 320 to generate task responses. The experience management system 106 can input the task prompt 314, the task prompt 316, and/or the task prompt 318 into a large language model (LLM) 222 (e.g., a pre-trained LLM). The experience management system 106 can cause the LLM 322 to generate one or more task responses (e.g., a task response 324, a task response 326, and/or a task response 328) based on the one or more task prompts (e.g., the task prompt 314, the task prompt 316, and/or the task prompt 318). The experience management system 106 can provide the one or more task prompts for display via an application of the client device 302. In some embodiments, the experience management system 106 can display the one or more task responses individually in the client device 302 (e.g., as separate notifications within the client device 302). In some embodiments, the experience management system 106 can combine one or more of the task responses for display in the client device 302. Moreover, in some embodiments, the experience management system 106 can include a request for additional user input in the task response (e.g., the task response 324, the task response 326, or the task response 328).

To continue the previously mentioned example of the experience management system 106 receiving a user prompt requesting flights to be booked from Los Angeles to London and Boston to London within the specified timeframe that arrive within an hour of each other, and determining a first task prompt (e.g., the task prompt 314, a first independent task prompt) to search flights from Los Angeles to London within the specified timeframe, a second task prompt (e.g., the task prompt 316, a second independent task prompt) to search flights from Boston to London, and a third task prompt (e.g., the task prompt 318, a first dependent task prompt that depends from the first and second independent task prompts) to have the flights from Los Angeles and Boston arrive within an hour of each other, the experience management system 106 can generate the task response 324 (e.g., a first task response) indicating that the experience management system 106 is searching for flights from Los Angeles to London, the task response 326 (e.g., a second task response), indicating that the experience management system 106 is searching for flights from Boston to London, and the task response 328 (e.g., a third task response) indicating that the experience management system 106 is filtering the flights from Los Angeles to London and Boston to London to ensure that they arrive within an hour of each other. In some embodiments, the experience management system 106 can include a request for additional input in the task item response, such as a preference for airline carrier and/or seat location. As previously mentioned, in some embodiments, the experience management system 106 can provide each task response as a separate notification in the client device 302. In some embodiments, the experience management system 106 can combine one or more of the task responses. For example, the experience management system 106 combine the task response 324 and the task response 326 and provide them as a first user response in the client device 302, and provide task response 328 as a second user response in the client device 302.

As illustrated, the experience management system 106 can perform an act 330 to orchestrate task items. Indeed, the experience management system 106 can cause the orchestrator agent layer 312 to receive the one or more task responses (e.g., the task response 324, the task response 326, and/or the task response 328) and generate one or more task items (e.g., a first task item instruction 332 and/or a second task item instruction 334) according to the task responses. To explain in another way, while the experience management system 106 can provide the one or more task responses for display on the client device as information for the user regarding the user prompt 304, the experience management system 106 can cause the orchestrator agent layer 312 to generate the task items (e.g., the first task item instruction 332 and/or the second task item instruction 334) to provide to an internal platform agent and/or a third-party platform agent 338 to cause the internal platform agent 336 and/or the third-party platform agent to accomplish a task item according to the task response(s).

To continue the above-mentioned example of the experience management system 106 generating the task response 324 of finding flights from Los Angeles to London within the specified timeframe, task response 326 of finding flights from Boston to London within the specified timeframe, and task response 328 of ensuring that the flights from Los Angeles and Boston arrive in London within an hour of each other, the experience management system 106 can provide the task response 324, the task response 326, and the task response 328 to the orchestrator agent layer 312. The experience management system 106 can cause the orchestrator agent layer 312 to generate one or more task items that include instructions to cause an agent to complete the task. Moreover, the experience management system 106 can cause the orchestrator to determine an appropriate agent to accomplish the task item. For example, the experience management system 106 can determine whether the internal platform agent 336 (e.g., an internal agent of the customer experience system 104 of FIG. 1) can complete the first task item instruction 332. Indeed, the experience management system 106 can determine whether the third-party platform agent 338 can complete the second task item instruction 334.

To continue the previously discussed example of the experience management system 106 booking flights from Los Angeles and Boston to London within a specified timeframe that arrive within an hour of each other, the experience management system 106 can determine whether the internal platform agent 336 can execute the first task item instruction 332. Responsive to a determination that the internal platform agent 336 cannot execute the first task item instruction 332, the experience management system 106 can determine an appropriate third-party agent (e.g., the third-party platform agent 338) to execute the second task item instruction 334. Indeed, in this example, the experience management system 106 can determine that the user prompt 304 includes travel by airplane. Accordingly, the experience management system 106 can determine that the third-party platform agent 338 needs to be an airline carrier (e.g., Delta, American Airlines, United Airlines, Southwest Airlines, etc.) The experience management system 106 can accordingly provide the task response 324, the task response 326, and/or the task response 328 to the orchestrator agent layer 312 and cause the orchestrator agent layer 312 to generate and provide the second task item instruction 334 to the third-party platform agent 338. Indeed, the experience management system 106 can determine if a single airline provider can meet the criteria of the second task item instruction 334. In some embodiments, the experience management system 106 can determine that multiple third-party platform agents are required to complete the second task item instruction 334.

The experience management system 106 can receive a task item status 342 from the internal platform agent 336 or the third-party platform agent 338 (e.g., the experience management system 106 can receive a task item status from the platform agent that the experience management system 106 provided the task item to). The task item status 342 can be an indication of progress from the platform agent regarding the task item. For example, the task item status 342 can indicate that the task item was successfully completed by the agent platform, that the task item was unsuccessfully completed by the agent platform, or that the agent platform is still in the process of completing the task item.

As illustrated, the experience management system 106 can perform act 340 to generate a user response according to the task item status received from the internal platform agent 336 or the third-party platform agent 338. The experience management system 106 can provide the user response for display in the client device 302, such as via an application of the client response.

To continue the example of the experience management system 106 securing flights from Los Angeles and Boston to London within a specified timeframe that arrive within an hour of each other, the experience management system 106 can generate the user response according to the task item status 342 received from the third-party platform agent 338 and provide the user response for display in an application of the client device 302. For example, according to a task item status 342 indication of successful completion of the second task item, the experience management system 106 can generate the user response to include information about the flight from Los Angeles to London and the flight from Boston to London. The experience management system 106 can generate one or more portions of the user response according to the task responses generated by the LLM 322. Additionally, the experience management system 106 can include the flight tickets for the trip from Los Angeles to London and the flight tickets for the trip from Boston to London in the user response.

As demonstrated by the foregoing discussion, the experience management system 106 increases the operational flexibility of implementing systems by generating one or more task prompts from a user prompt 304, generating task responses according to the user prompt 304, and orchestrating one or more task items according to the one or more task prompts. The experience management system 106 interacts with one or more third-party platform agents to complete tasks indicated by the task prompt. Moreover, the experience management system 106 increases the navigational efficiency of implementing systems by reducing the navigation required for a user to complete task items associated with user prompts. Through the orchestrator agent layer 312, the experience management system 106 completes task items rather than repeatedly requiring user input.

As previously mentioned, the experience management system 106 can utilize an LLM including fine-tuned layers to generate user responses to user prompts. FIG. 4 illustrates an example architecture utilized by the experience management system 106 to generate responses to user prompts.

As illustrated, the experience management system 106 can receive user prompt(s) 402 through a plurality of channels (e.g., a channel 404, a channel 406, a channel 408, and/or a channel 410). Each of the plurality of channels can be associated with a client device associated with a user. Moreover, each of the plurality of channels can be multi-modal and therefore capable of receiving a variety of types of user prompt(s) 402. For example, the experience management system 106 can cause one or more of the plurality of channels can receive user prompt(s) 402 of natural language texts, documents (e.g., PDFs, word documents, or other text-based formats), audio input (e.g., human speech), visual prompts (e.g., images and/or video), structured data, and/or a combination of the aforementioned.

As illustrated, the experience management system 106 can input the user prompt(s) 402 into an agent layer 422. The experience management system 106 can cause a monitoring agent layer 412 of the agent layer 422 to monitor the user prompt(s). Indeed, the experience management system 106 can utilize security protocols 448 to monitor the user prompt(s) 402 for security threats, such as, for example, jailbreaks. The security protocols 448 can include methods such as content filtering (e.g., keyword filtering, phrase filtering, pattern recognition, among others), behavioral analysis (e.g., anomaly detection and/or user behavior tracking, among others), contextual understanding (e.g., contextual analysis and/or multi-turn context, among others), real-time moderation (e.g., moderation by a user and/or automated moderation, among others), adaptive learning (e.g., continuous training and/or feedback loops, among others), technical safeguards (e.g., rate limiting and/or sandboxing, among others), as well as ethical guidelines and policies (e.g., ethical training and/or keeping transparent logs of AI interactions) to monitor the user prompt(s). Responsive to detecting a security threat according to the security protocols 448, the experience management system 106 can transform the user prompt(s) 402 to remove the security threat from the user prompt(s). The experience management system 106 can store transformations, edits, or any other changes to the user prompt(s) as user prompt transforms 444.

Moreover, the experience management system 106 can cause the monitoring agent layer 412 to provide the user prompt(s) 402 to an orchestrator agent layer 450. Thereafter, the experience management system 106 can cause the orchestrator agent layer to process the user prompt(s) 402 to generate one or more task prompts from the user prompt(s) 402. The experience management system 106 can cause the orchestrator agent layer 450 to provide the one or more task prompts to a pre-trained LLM (e.g., the large language model 436). The experience management system 106 can cause the pre-trained LLM to generate one or more task responses based on the one or more task prompts.

Indeed, as illustrated, the experience management system 106 can utilize adapters 434 (e.g., one or more adapters) to interface with the LLM 436. For example, the experience management system 106 can utilize the adapters 434 to convert data formats of data (e.g., the user prompt(s) 402, the one or more task prompts, the one or more task responses, task item instructions, task item statuses, user responses, and/or other forms of data) for use by the agent layer 422 and the LLM 436. For example, the experience management system 106 can cause the adapters 434 to modify the one or more task prompts from a first format (e.g., a format utilized by the agent layer 422) to a second format (e.g., a format utilized by the LLM 436). The experience management system 106 can input the second format of the one or more task prompts to the LLM 436 (e.g., the pre-trained large language model). Additionally or alternatively, the experience management system 106 can cause the adapters 434 to modify the one or more task responses from a first format (e.g., a format utilized by the LLM 436) to a second format (e.g., a format utilized by the agent layer 422). The experience management system 106 can provide the second format of the one or more task responses to the orchestrator agent layer

As illustrated, the large language model 436 can include fine-tuned layers 438 and a knowledge graph 440. The experience management system 106 can construct the knowledge graph 440 to include nodes representative of users of a customer experience system (e.g., the customer experience system 104 of FIG. 1). The experience management system 106 can connect the nodes of the knowledge graph 440 with edges, and utilize the edges to represent relationships between nodes (e.g., users) within the customer experience system. For example, the experience management system 106 can represent a high degree of similarity between nodes (e.g., users) as short edges, and lesser degrees of similarity between nodes (e.g., users) as long edges.

Moreover, the experience management system 106 can generate the fine-tuned layers 438 of the LLM 436. For example, the experience management system 106 can generate a first fine-tuned layer of the LLM 436 utilizing demographic data from the knowledge graph 440 and/or customer experience system. Moreover, the experience management system 106 can generate a second fine-tuned layer of the LLM 436 utilizing preference and/or experience data within an industry. Additionally, the experience management system 106 can generate a third fine-tuned layer of the LLM 436 that are specialized for specific tasks within an industry (e.g., a domain layer).

The experience management system 106 can cause the LLM 436 to provide the task responses to the orchestrator agent layer 450. Moreover, the experience management system 106 can cause the orchestrator agent layer 450 to orchestrate one or more task items by causing the orchestrator agent layer 450 by providing a task item instruction to a platform agent. Indeed, the experience management system 106 can determine a platform agent to complete a task item instruction. For example, the experience management system 106 can determine whether the customer experience system can complete the task item instruction. Upon a determination that the customer experience system can complete the task item instruction, the experience management system 106 can provide a first task item instruction to an internal platform agent (e.g., an internal platform agent 416, an internal platform agent 418, or an internal platform agent 420). Responsive to a determination that the customer experience system cannot complete the task instruction, the experience management system 106 can provide a second task instruction to an agent of a third-party platform 424 (e.g., a third-party platform agent 426 or a third-party platform agent 452).

As illustrated, the experience management system 106 can cause the agent layer 422 to communicate or otherwise interface with a service/API gateway 454. For example, the experience management system 106 can receive data from the service/API gateway 454 during the process of generating a user response for the user prompt(s) 402. In some embodiments, the experience management system 106 can receive the third-party data as a result of a service bus 428 and/or a third-party system of engagement (SoE)/system of record (SoR) 330 pushing the data to the agent layer 422 via the service/API gateway 454. Indeed, in some embodiments, the SoE/SoR 430 can retrieve the data from a third-party database (DB)/lake 432. Indeed, the experience management system 106 can determine to update one or more of the one or more task prompts, the one or more task responses, or the task item instruction(s) according to data received from the service/API gateway 454.

Additionally or alternatively, the experience management system 106 can determine, responsive to the user prompt(s) 402, the one or more task prompts, and/or the one or more task responses, to acquire more data from a third-party. Accordingly, the experience management system 106 can request the third-party data via the service/API gateway 454. In some instances, the experience management system 106 can cause the service/API gateway 454 to fetch or otherwise retrieve the third-party data from the service/API gateway 454. Indeed, the experience management system 106 can cause the service/API gateway 454 to communicate with, send or retrieve data from the service bus 428 and/or the SoE/SoR 430.

Indeed, the experience management system 106 can cause the orchestrator agent layer 450 to generate one or more task item statuses based on a level of completion of the task item instruction(s) (e.g., the first task item instruction and/or the second task item instruction). For example, the experience management system 106 can determine that the experience management system 106 successfully completed the task item instruction and generate the task item status indicating successful completion of the task item instruction. Additionally or alternatively, the experience management system 106 can determine that the experience management system 106 did not successfully complete the task item instruction and generate the task item status indicating unsuccessful completion of the task item instruction. Additionally or alternatively, the experience management system 106 can determine that the experience management system 106 is still in the process of completing the task item instruction and generate the task item instruction indicating that the experience management system 106 is in the process of completing the task item instruction. Thereafter, the experience management system 106 can generate a user response to the user prompt(s) 402 according to the task item status.

As illustrated, the experience management system 106 can perform act 442 to monitor measurements of channels/client devices. Indeed, the experience management system 106 can monitor prompt characteristics associated with the user prompt(s) for an escalation event, such as voice escalation or loud noises. Responsive to detecting an escalation event, the experience management system 106 can perform a de-escalation action according to the escalation event. For example, responsive to detecting elevated voice levels from the plurality of connected channels, such as a user yelling in frustration, the experience management system 106 can determine to connect the user with a representative of a third-party platform. Indeed, the experience management system 106 can determine to perform a de-escalating action according to the escalation event (e.g., the experience management system 106 can perform specific de-escalation actions based on characteristics of the escalation event).

Indeed, the experience management system 106 can utilize the knowledge graph 440 and/or the fine-tuned layers 438 of the LLM 436 to augment any actions performed by the experience management system 106 in the process of generating a user response. For example, the experience management system 106 can utilize the knowledge graph 440 to augment the user prompt(s) 402, the one or more task prompts, the one or more task responses, the one or more task item instructions, the task item status, and/or the user response. For example, the experience management system 106 can utilize data from the knowledge graph 440 to augment a task prompt, task response, and/or task item instruction with user preferences for an airline carrier, flight departure or arrival times, or seat selection for a flight.

As illustrated, the experience management system 106 can cause the agent layer 422 apply user response filters 446 to the user response prior to providing the user response to a client device. Indeed, the experience management system 106 can implement the user response filters 446 as part of the security protocols 448 to ensure quality and integrity of the user response. For example, the experience management system 106 can utilize the user response filters 446 to remove any harmful or incorrect information from the user response. Based on applying the user response filters 446 to the user response, the experience management system 106 can provide the user response via an application of the client device.

In one or more embodiments, the experience management system 106 can utilize the monitoring agent layer 412 to actively and passively monitor the user prompt 402. For example, in addition to utilizing one or more security protocols 448 to transform the user prompt 402, the experience management system 106 can determine content items and/or other sources of data related to the user prompt 402. Based on determining the content items and/or other sources of data related to the user prompt 402, the experience management system 106 can determine access permissions for the content items and/or other sources of data (e.g., the experience management system 106 can identify additional user accounts that have access to the content items and/or other sources of data). Based on identifying the access permissions for the content items and/or other sources of data, the experience management system 106 can determine to modify the access permissions. Moreover, the experience management system 106 can utilize the monitoring agent layer 412 to monitor what content items are accessed by the internal platform agents, large language model 436, and/or third-party platform 424.

Moreover, in some embodiments, responsive to receiving the user prompt, the experience management system 106 can determine one or more additional client devices to utilize to generate task prompts, task responses, task items, and/or user responses. As a part of generating the user response, the experience management system 106 can determine relationships between any of the task prompts, task responses, task items, task item instructions, task item statuses, user responses, and additional client devices. Indeed, the experience management system 106 can determine a first additional client device associated with a task item status, and utilize the first additional client device to generate the user response.

To provide an example, the experience management system 106 can receive a user prompt requesting to organize travel plans for a user account. Responsive to receiving the request to organize travel plans, the experience management system 106 can process the user prompt and generate one or more task prompts. Indeed, the experience management system can determine that at least one of the one or more task prompts relates to providing updates to the user account during the time of the travel plans. The experience management system 106 can determine the first additional client device according to the one or more task prompts. Based on determining the first additional client device according to the one or more task prompts, the experience management system 106 can determine to utilize the first additional client device to generate the user response.

Moreover, in some embodiments, the experience management system 106 can generate one or more task prompts from the user prompt to augment the user prompt. Phrased differently, the experience management system 106 can process the user prompt to autonomously determine task prompts from the user prompt. Indeed, the experience management system 106 can autonomously determine a subset of the one or more task prompts to provide a personalized experience for the user account. Indeed, the experience management system 106 can determine an operational area (e.g., a subject) from the user prompt. The experience management system 106 can determine adjacent and/or otherwise related operational areas from the operational area. Based on determining the adjacent and/or otherwise related operational areas from the operational area, the experience management system 106 can determine the subset of the one or more task prompts according to the adjacent and/or otherwise related operational areas.

For example, the experience management system 106 can receive a user prompt 402 requesting the experience management system 106 to organize a flight travel plan for a user account. Based on receiving the user prompt, the experience management system 106 can utilize the orchestrator agent layer 450 to determine that the operational area of the user prompt is “flight travel.” Based on determining that the operational area of the user prompt 402 is “flight travel,” the experience management system 106 can utilize the orchestrator agent layer 450 to determine a first adjacent operational area, such as “travel to an origin airport.” Moreover, the experience management system 106 can utilize the orchestrator agent layer 450 to determine a second adjacent operational area, such as “travel from a destination airport.” Additionally, the experience management system 106 can utilize the orchestrator agent layer 450 determine a third adjacent operational area, such as “entertainment at destination location.” Indeed, the experience management system 106 can utilize the orchestrator agent layer 450 to determine a fourth adjacent operational area, such as “entertainment during flight.” Moreover, the experience management system 106 can utilize the orchestrator agent layer 450 to determine a fifth adjacent operational area, such as “contingency travel plans.” Based on determining the adjacent operational areas, the experience management system 106 can utilize the orchestrator agent layer 450 to autonomously determine the subset of the task prompts to personalize and/or otherwise augment the user response and/or additional user responses.

FIGS. 1-4, the corresponding text, and the examples provide a number of different methods, systems, devices, and non-transitory computer-readable media of the experience management system 106. In addition to the foregoing, one or more embodiments can also be described in terms of flowcharts comprising acts for accomplishing the particular result, as shown in FIG. 5. FIG. 5 may be performed with more or fewer acts. Further, the acts may be performed in different orders. Additionally, the acts described herein may be repeated or performed in parallel with one another or in parallel with different instances of the same or similar acts.

While FIG. 5 illustrates acts according to certain implementations, alternative implementations may omit, add to, reorder and/or modify any of the acts shown in FIG. 5. The acts of FIG. 5 can be performed as part of a computer-implemented method. Alternatively, a non-transitory computer readable medium can comprise actions that, when implemented by one or more processors, cause a computing device to perform the acts of FIG. 5. In still further embodiments, a system can perform the acts of FIG. 5.

As illustrated in FIG. 5, a series of acts 500 can include an act 502 of receiving a user prompt. In particular, the act 502 can include receiving, at a monitoring agent layer, a user prompt from a client device associated with a user via a channel from plurality of connected channels, the monitoring agent layer monitoring prompt characteristics associated with the user prompt prior to providing the user prompt to an orchestrator agent layer. In addition, the series of acts 500 can include an act 504 of processing the user prompt to generate task prompts. In particular, the act 504 can include processing, by the orchestrator agent layer, the user prompt to generate one or more task prompts from the user prompt. Moreover, the series of acts 500 can include an act 506 of providing the task prompts to a large language model to generate task responses. In particular, the act 506 can include providing the one or more task prompts to a pre-trained large language model to generate one or more task responses based on the one or more task prompts, wherein the pre-trained large language model comprises one or more fine-tuned layers. In addition, the series of acts 500 can include an act 508 of orchestrating task items. In particular, the act 508 can include orchestrating, based on the orchestrator agent layer receiving the one or more task responses, one or more task items by providing a first task item instruction to an internal platform agent or a second task item instruction to a third-party platform agent. Further, the series of acts 500 can include an act 510 of generating a user response. In particular, the act 510 can include generating a user response to the user prompt according to a task item status received from the internal platform agent or the third-party platform agent.

In some embodiments, the series of acts 500 further includes transforming, by the monitoring agent layer, the user prompt based on to one or more security protocols. In addition, in some embodiments, the series of acts 500 includes filtering the user response according to one or more security protocols prior to providing the user response to the client device associated with the user.

In some embodiments, the series of acts 500 includes generating the one or more fine-tuned layers of the pre-trained large language model, wherein the one or more fine-tuned layers include at least one of: a demographics layer, an industry layer, or a domain layer. Further, in some embodiments, the series of acts 500 includes generating the one or more fine-tuned layers according to a knowledge graph.

In addition, in some embodiments, the series of acts 500 includes determining, by the monitoring agent layer, an escalation event associated with a user based on monitoring the prompt characteristics associated with the user prompt. Moreover, in some embodiments, the series of acts 500 further includes performing a de-escalating action according to the escalation event.

Additionally, in some embodiments, the series of acts 500 includes providing the one or more task prompts to one or more adapters. Further, in one or more embodiments, the series of acts 500 includes modifying, by the one or more adapters, the one or more task prompts from a first format to a second format. Indeed, in some embodiments, the series of acts 500 includes inputting the second format of the one or more task prompts to the pre-trained large language model.

In one or more embodiments, the series of acts 500 includes providing the one or more task responses to one or more adapters. In addition, in some embodiments, the series of acts 500 includes modifying, by the one or more adapters, the one or more task responses from a first format to a second format. Moreover, in one or more embodiments, the series of acts 500 includes providing the second format of the one or more task responses to the orchestrator agent layer.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of computing device 600 that can be configured to perform one or more of the processes described above. One will appreciate that one or more computing devices, such as the computing device 600, can implement the various devices of the environment of FIG. 1. As shown by FIG. 6, the computing device 600 can comprise a processor 602, a memory 604, a storage device 606, an I/O interface 608, and a communication interface 610, which can be communicatively coupled by way of a communication infrastructure 612. While a computing device 600 is shown in FIG. 6, the components illustrated in FIG. 6 are not intended to be limiting. Additional or alternative components can be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example, and not by way of limitation, to execute instructions, the processor 602 can retrieve (or fetch) the instructions from an internal register, an internal cache, the memory 604, or the storage device 606 and decode and execute them. In one or more embodiments, the processor 602 can include one or more internal caches for data, instructions, or addresses. As an example, and not by way of limitation, the processor 602 can include one or more instruction caches, one or more data caches, and one or more translation lookaside buffers (TLBs). Instructions in the instruction caches can be copies of instructions in the memory 604 or the storage device 606.

The memory 604 can be used for storing data, metadata, and programs for execution by the processor(s). The memory 604 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 can be internal or distributed memory.

The storage device 606 includes storage for storing data or instructions. As an example, and not by way of limitation, storage device 606 can comprise a non-transitory storage medium described above. The storage device 606 can include a hard disk drive (HDD), a floppy disk drive, flash memory, an optical disc, a magneto-optical disc, magnetic tape, or a Universal Serial Bus (USB) drive or a combination of two or more of these. The storage device 606 can include removable or non-removable (or fixed) media, where appropriate. The storage device 606 can be internal or external to the computing device 600. In one or more embodiments, the storage device 606 is non-volatile, solid-state memory. In other embodiments, the storage device 606 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 can include a mouse, a keypad or a keyboard, a touch screen, a camera, an optical scanner, network interface, modem, other known I/O devices or a combination of such I/O interfaces. The I/O interface 608 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data can be representative of one or more graphical user interfaces and/or any other graphical content as can serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example, and not by way of limitation, the communication interface 610 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 610 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 610 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 can include hardware, software, or both that couples components of the computing device 600 to each other. As an example and not by way of limitation, the communication infrastructure 612 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

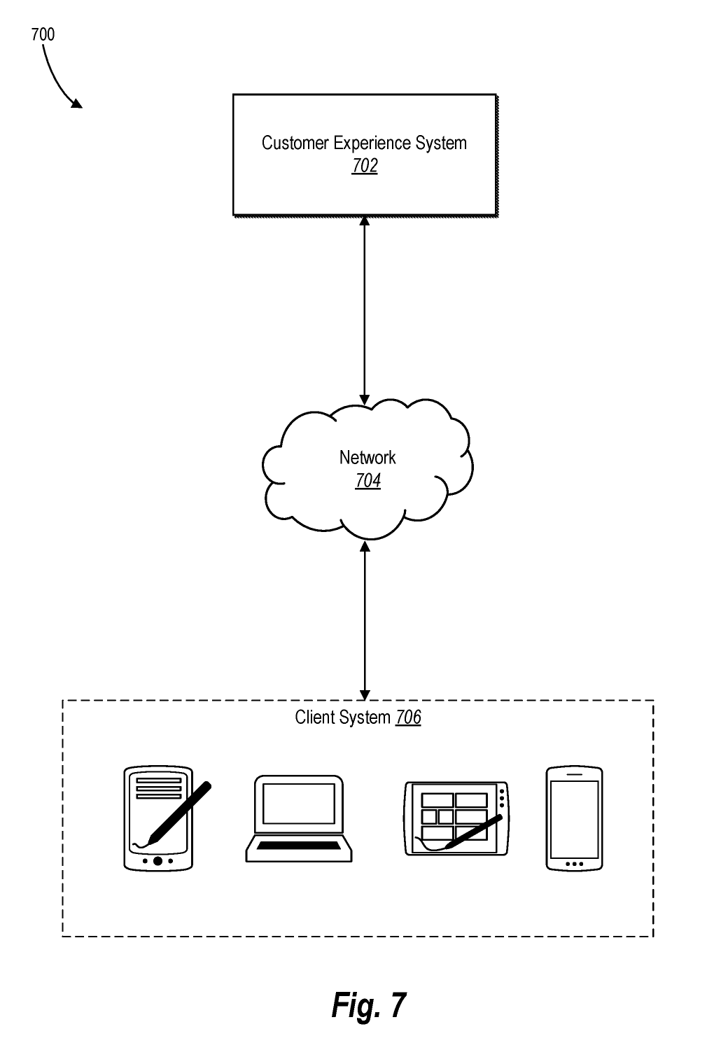

FIG. 7 illustrates an example network environment 700. Network environment 700 includes a client system 706, and a customer experience system 702 (e.g., the customer experience system 104 of FIG. 1) connected to each other by a network 704. Although FIG. 7 illustrates a particular arrangement of client system 706, customer experience system 702, and network 704, this disclosure contemplates any suitable arrangement of client system 706, customer experience system 702, and network 704. As an example, and not by way of limitation, two or more of client system 706, and customer experience system 702 can be connected to each other directly, bypassing network 704. As another example, two or more of client system 706 and customer experience system 702 can be physically or logically co-located with each other in whole, or in part. Moreover, although FIG. 7 illustrates a particular number of client systems 706, customer experience system 702, and network 704, this disclosure contemplates any suitable number of client systems 706, customer experience system 702, and network 704. As an example, and not by way of limitation, network environment 700 can include multiple client systems 706, customer experience system 702, and network 704.

This disclosure contemplates any suitable network 704. As an example and not by way of limitation, one or more portions of network 704 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 can include one or more networks.

Links can connect client system 706, and customer experience system 702 to network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links can differ in one or more respects from one or more second links.

In particular embodiments, client system 706 can be an electronic device including hardware, software, or embedded logic components or a combination of two or more such components and capable of carrying out the appropriate functionalities implemented or supported by client system 706. As an example, and not by way of limitation, a client system 706 can include any of the computing devices discussed above in relation to FIG. 7. A client system 706 can enable a network user at client system 706 to access network 704. A client system 706 can enable its user to communicate with other users at other client devices or systems.

In particular embodiments, client system 706 can include a web browser, such as MICROSOFT EDGE, GOOGLE CHROME, or MOZILLA FIREFOX, and can have one or more add-ons, plug-ins, or other extensions, such as TOOLBAR or YAHOO TOOLBAR. A user at client system 706 can enter a Uniform Resource Locator (URL) or other address directing the web browser to a particular server (such as server, or a server associated with a third-party system), and the web browser can generate a Hyper Text Transfer Protocol (HTTP) request and communicate the HTTP request to server. The server can accept the HTTP request and communicate to client system 706 one or more Hyper Text Markup Language (HTML) files responsive to the HTTP request. Client system 706 can render a webpage based on the HTML files from the server for presentation to the user. This disclosure contemplates any suitable webpage files. As an example, and not by way of limitation, webpages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, customer experience system 702 can include a variety of servers, sub-systems, programs, modules, logs, and data stores. In particular embodiments, customer experience system 702 can include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Customer experience system 702 can also include suitable components such as network interfaces, security mechanisms, load balancers, failover servers, management-and-network-operations consoles, other suitable components, or any suitable combination thereof.

In particular embodiments, customer experience system 702 can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, at a monitoring agent layer, a user prompt from a client device associated with a user via a channel from plurality of connected channels, the monitoring agent layer monitoring prompt characteristics associated with the user prompt prior to providing the user prompt to an orchestrator agent layer;
processing, by the orchestrator agent layer, the user prompt to generate one or more task prompts from the user prompt;
providing the one or more task prompts to a pre-trained large language model to generate one or more task responses based on the one or more task prompts, wherein the pre-trained large language model comprises one or more fine-tuned layers;
orchestrating, based on the orchestrator agent layer receiving the one or more task responses, one or more task items by providing a first task item instruction to an internal platform agent or a second task item instruction to a third-party platform agent; and
generating a user response to the user prompt according to a task item status received from the internal platform agent or the third-party platform agent.

2. The computer-implemented method of claim 1, further comprising transforming, by the monitoring agent layer, the user prompt based on one or more security protocols.

3. The computer-implemented method of claim 1, further comprising filtering the user response according to one or more security protocols prior to providing the user response to the client device associated with the user.

4. The computer-implemented method of claim 1, further comprising generating the one or more fine-tuned layers of the pre-trained large language model, wherein the one or more fine-tuned layers include at least one of: a demographics layer, an industry layer, or a domain layer.

5. The computer-implemented method of claim 4, further comprising generating the one or more fine-tuned layers according to a knowledge graph.

6. The computer-implemented method of claim 1, further comprising:
determining, by the monitoring agent layer, an escalation event associated with a user based on monitoring the prompt characteristics associated with the user prompt; and
performing a de-escalating action according to the escalation event.

7. The computer-implemented method of claim 1, further comprising:
providing the one or more task prompts to one or more adapters;
modifying, by the one or more adapters, the one or more task prompts from a first format to a second format; and
inputting the second format of the one or more task prompts to the pre-trained large language model.

8. The computer-implemented method of claim 1, further comprising:
providing the one or more task responses to one or more adapters;
modifying, by the one or more adapters, the one or more task responses from a first format to a second format; and
providing the second format of the one or more task responses to the orchestrator agent layer.

9. A system comprising:
at least one processor; and
at least one non-transitory computer-readable storage medium storing instructions that, when executed by the at least one processor, cause the system to:
receive, at a monitoring agent layer, a user prompt from a client device associated with a user via a channel from plurality of connected channels, the monitoring agent layer monitoring prompt characteristics associated with the user prompt prior to providing the user prompt to an orchestrator agent layer;
process, by the orchestrator agent layer, the user prompt to generate one or more task prompts from the user prompt;
provide the one or more task prompts to a pre-trained large language model to generate one or more task responses based on the one or more task prompts, wherein the pre-trained large language model comprises one or more fine-tuned layers;
orchestrate, based on the orchestrator agent layer receiving the one or more task responses, one or more task items by providing a first task item instruction to an internal platform agent or a second task item instruction to a third-party platform agent; and
generate a user response to the user prompt according to a task item status received from the internal platform agent or the third-party platform agent.

10. The system of claim 9, further comprising instructions that, when executed by the at least one processor, cause the system to transform, by the monitoring agent layer, the user prompt based on one or more security protocols.

11. The system of claim 9, further comprising instructions that, when executed by the at least one processor, cause the system to filter the user response according to one or more security protocols prior to providing the user response to the client device associated with the user.

12. The system of claim 9, further comprising instructions that, when executed by the at least one processor, cause the system to generate the one or more fine-tuned layers of the pre-trained large language model, wherein the one or more fine-tuned layers include at least one of: a demographics layer, an industry layer, or a domain layer.

13. The system of claim 12, further comprising instructions that, when executed by the at least one processor, cause the system to generate the one or more fine-tuned layers according to a knowledge graph.

14. The system of claim 9, further comprising instructions that, when executed by the at least one processor, cause the system to:
determine, by the monitoring agent layer, an escalation event associated with a user based on monitoring the prompt characteristics associated with the user prompt; and
perform a de-escalating action according to the escalation event.+

15. The system of claim 9, further comprising instructions that, when executed by the at least one processor, cause the system to:
provide the one or more task prompts to one or more adapters;
modify, by the one or more adapters, the one or more task prompts from a first format to a second format; and
input the second format of the one or more task prompts to the pre-trained large language model.

16. A non-transitory computer-readable medium storing instructions thereon that, when executed by at least one processor, cause a computing device to:
receive, at a monitoring agent layer, a user prompt from a client device associated with a user via a channel from plurality of connected channels, the monitoring agent layer monitoring prompt characteristics associated with the user prompt prior to providing the user prompt to an orchestrator agent layer;
process, by the orchestrator agent layer, the user prompt to generate one or more task prompts from the user prompt;
provide the one or more task prompts to a pre-trained large language model to generate one or more task responses based on the one or more task prompts, wherein the pre-trained large language model comprises one or more fine-tuned layers;
orchestrate, based on the orchestrator agent layer receiving the one or more task responses, one or more task items by providing a first task item instruction to an internal platform agent or a second task item instruction to a third-party platform agent; and
generate a user response to the user prompt according to a task item status received from the internal platform agent or the third-party platform agent.

17. The non-transitory computer-readable medium of claim 16, further comprising instructions that, when executed by the at least one processor, cause the computing device to transform, by the monitoring agent layer, the user prompt based on one or more security protocols.

18. The non-transitory computer-readable medium of claim 16, further comprising instructions that, when executed by the at least one processor, cause the computing device to filter the user response according to one or more security protocols prior to providing the user response to the client device associated with the user.

19. The non-transitory computer-readable medium of claim 16, further comprising instructions that, when executed by the at least one processor, cause the computing device to generate the one or more fine-tuned layers of the pre-trained large language model, wherein the one or more fine-tuned layers include at least one of: a demographics layer, an industry layer, or a domain layer.

20. The non-transitory computer-readable medium of claim 16, further comprising instructions that, when executed by the at least one processor, cause the computing device to:
determine, by the monitoring agent layer, an escalation event associated with a user based on monitoring the prompt characteristics associated with the user prompt; and
perform a de-escalating action according to the escalation event.
